(19) United States
(12) Patent Application Publication
(10) Pub. No.: US 2006/0129577 A1
(43) Pub. Date: Jun. 15, 2006

(54) Apparatus, program and method for assisting with product design

(75) Inventor: Naoyuki Nozaki, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/298,757

(22) Filed: Dec. 12, 2005

(30) Foreign Application Priority Data
Dec. 15, 2004 (JP) 2004-362516

(51) Int. Cl. G06F 7/00

(52) U.S. Cl. 707/100

(57) ABSTRACT

The present invention allows a user to visually check on a display screen the correspondence relationship between a shape and two or more attributes in a case in which shape information is associated with a plurality of attributes by providing a means that causes two or more selected attributes to correspond to respectively independent display information, combining them, and updating the shape display information. The information processing apparatus relating to the present invention is such that, in an information processing apparatus that is able to discriminably represent a plurality of components that configure a product and that assists in product design, it has an attribute information selection portion that selects the desired two or more pieces of attribute information from the plurality of attribute information that the component has, a representation selection portion that selects the representations that represent the two or more pieces of attribute information in order to discriminate the component, and a component attribute value has been selected in the plurality of selected attribute information.

### CROSS-REFERENCE TO RELATED APPLICATIONS

This application is based upon and claims priority to Japanese Patent Application No. 2004-362516, filed on Dec. 15, 2004, the contents being incorporated herein by reference.

### BACKGROUND OF THE INVENTION

1. Field of the Invention

The present invention relates to the design of manufactured products, etc. using Computer Aided Design (CAD) or Digital Mock-Up (DMU) and Computer Aided Manufacturing (CAM).

2. Description of the Related Art

In recent years, in the manufacture and development of a variety of products, manufacturing and development approaches that take into account the global environment are being pursued.

In order to perform manufacturing and development that take into account the recycling of natural resources, such as dismantlability, for example, it is necessary to perform simulation design on a computer. In particular the simulation is performed to simulate the materials used in the components that configure the product, the arrangement locations, etc. in addition, it is necessary to perform optical product assembly. The document discussed below relates to design methods that take into account recyclability to assist product development.

Japanese Unexamined Patent Application Publication 2003-271677 discloses a method that can be used when product design is performed as a means of visually discriminating from the display status the type of attribute being assigned to a component. In a case in which information to which a variety of attributes such as material belong, shape information that represents the shape of that component are displayed using CAD or the like on a display apparatus of an information processing apparatus. Display statuses such as the color that conform to an attribute value are assigned for one attribute, and the display is switched to visually discriminate differences according to the attribute.

FIG. 17 is table that shows the attributes of components A, B, and C. The attributes are the material 1705 and the recyclability ratio 1707, where for component A, the material 1705 is iron and the recyclability ratio 1707 is 80 percent. For component B, the material 1709 is aluminum and the recyclability ratio 1711 is 50 percent. For component C, the material 1713 is plastic and the recyclability ratio 1715 is 5 percent.

FIG. 18 is a drawing that shows the correspondence relationship between a material 1805, a recyclability ratio 1810, and color in hue table 1815. FIG. 19 is a table that shows a correspondence relationship between the recyclability ratio value and color. The material iron 1905 is made to correspond to red, aluminum 1910 to blue, and plastic 1915 to green. A recyclability ratio of 0 to 30 percent 1920 corresponds to red, 31 to 70 percent 1925 to yellow, and 71 to 100 percent 1930 to purple. Here, with respect to the material and recyclability ratio, in addition to color, it is also possible to provide a correspondence with such attributes using luminance and transparency.

After a correspondence table has been created, it will be possible to visually ascertain the attribute value by making the component color a color (and/or luminance/transparency) of corresponds to an attribute value that the component. In this method, it is possible to manage the correspondence table for each attribute, and it is possible to make visual evaluation easy by switching the attribute for one which a user would like to perform or show component color-coding. For example, when a material is selected as the attribute, it is possible to confirm on the screen which material is used in the component.

In the same way, it is possible to visually confirm the difference in the recyclability ratios of the component for which color-coding has been performed in the recyclability ratio, and product design that takes into account dismantlability becomes easy.

Through the aforementioned method, with respect to the materials being used in the components, for example, it is possible to visually recognize on the display screen what material the component is using by managing the colors that correspond to the respective materials. The method described is effective in the work of sequentially evaluating the visual evaluations with respect to the attributes of material, recyclability ratio, and dismantlability.

However, in a case in which product dismantlability evaluation is performed as a part of the environmental evaluation of the product to be designed, for example, a need exists to determine whether the material being used in a component is a metal group or a resin group and to further know whether the adjacent component is the same material.

The above-identified type of need exists because there are differences in work in that needs to be done when breaking down components; most of the resin group cannot be recycled. So it is okay not to break it down carefully. If adjacent components are the same material, those components need not be broken down.

For example, FIG. 20 is a table that shows the attributes of components A, B and C. The attributes are the material and classification. For component A, the material 2005 is iron and the classification 2000 is metal. For component B, the material 2015 is aluminum and the classification 2020 is metal. For component C, the material 2025 is plastic and the classification 2030 is resin.

FIG. 21 is a drawing that shows the correspondence relationship between material 2105, classification value 2110, and color in hue table 2115. FIG. 22 is a table that shows the correspondence relationship between material, classification value, and color. The material iron 2205 is made to correspond to red, aluminum 2210 to blue, and plastic 2215 to green. If the classification is metal 2220, it is made to correspond to red, and if it is resin 2225, to yellow.

FIG. 23 is an overview diagram of components A, B, and C, and the frame is considered the display screen. For component A 2301, the material 2305 is iron and the classification 2310 is metal. For component B 2302, the material 2315 is aluminum and the classification 2317 is metal. For component C 2303, the material 2319 is plastic and the classification 2321 is resin. So, in the case in which display is performed in relation to the classifications from FIG. 21 and FIG. 22, component A 2301 is displayed in red, component B 2302 in red, and component C 2303 in yellow, and in the case in which display is performed in relation to material, component A 2301 is displayed in red, component B 2302 in blue, and component C 2303 in green.

In actuality, the product is displayed in relation to the classification, material, etc. in a status that has been combined according to components A, B, C, etc. Product evaluation may be performed by color display in a status in which the product has been broken down by component. In addition, environmental evaluation, etc. of the product will be performed while alternately referring to the two color-coding screens of material and classification. In this method, since evaluation is performed while the screen is being switched, one must remember one of the statuses, and a problem occurs in that when the number of component points or the number of attribute values is increased, evaluation became difficult.

In addition, when dismantling the apparatus, since a determination is made as to whether further dismantling is necessary in conjunction with confirming whether or not the material is recyclable, it was also necessary to check whether or not the components being assembled were the same material. In such a case, heretofore, there were problems in that it was necessary to evaluate while switching the display status. This resulted from the attribute of recyclability and the display status resulting from the attribute of the material, was poor i.e. inefficient. Oversights also occurred.

### BRIEF DESCRIPTION OF THE INVENTION

In the present invention, the purpose is to make it possible to visually check on a display screen the correspondence relationship between the shape and two or more attributes. In the case in which shape information is associated with a plurality of attributes, a means is provided that causes two or more selected attributes to correspond to respectively independent display information, combining them, and updating the shape display information. In at least one embodiment, the invention is directed to an information processing apparatus capable of discriminably representing a plurality of components that configure a product and that assists in product design.

The information processing apparatus includes an attribute information selection portion that selects two or more pieces of attribute information from attribute information of the component, a representation selection portion that selects representations of the two or more pieces of attribute information with respect to respective attribute information to discriminate the component, and a component representation portion that represents shape of the component based on the representation for which a component-specific attribute value has been selected in the selected attribute information.

### BRIEF DESCRIPTION OF THE DRAWINGS

FIG. 1 is a classification table of the materials assigned to the components.

FIG. 2 is a drawing of assignment of hues and lightness to the classification table.

FIG. 3 is a drawing that shows correspondences between the hue and lightness table and the classifications and materials.

FIG. 4 is a table that shows correspondences between the hue and lightness table and the classifications and materials.

FIG. 5 is a drawing that shows correspondences between the hue and lightness table and the recyclability ratio and materials.

FIG. 6 is a table that shows correspondences between the hue and lightness table and the recyclability ratio and materials.

FIG. 7 is a drawing of assignment of hues and transparencies to the classification table.

FIG. 8 is a drawing that shows correspondences between the hue and transparency table and the classifications and materials.

FIG. 9 is a table that shows correspondences between the hue and transparency table and the classifications and materials.

FIG. 10 is a drawing that shows correspondences between the hue and transparency table and the recyclability ratio and materials.

FIG. 11 is a table that shows correspondences between the hue and transparency table and the recyclability ratio and materials.

FIG. 12 is a block diagram of the information processing apparatus relating to the present invention.

FIG. 13 is a flowchart relating to the first example of embodiment of the present invention.

FIG. 14 is a flowchart relating to the second example of embodiment of the present invention.

FIG. 15 is a flowchart relating to the third example of embodiment of the present invention.

FIG. 16 is a flowchart relating to the fourth example of embodiment of the present invention.

FIG. 17 is a table that shows the attributes of components A, B, and C.

FIG. 18 is a drawing that shows correspondences between the color table and the recyclability ratio and materials.

FIG. 19 is a table that shows correspondences between the color table and the recyclability ratio and materials.

FIG. 20 is a table that shows the attributes of components A, B, and C.

FIG. 21 is a drawing that shows correspondences between the color table and the classifications and materials.

FIG. 22 is a table that shows correspondences between the color table and the classifications and materials.

FIG. 23 is an overview diagram of components A, B, C.

### DETAILED DESCRIPTION OF THE PREFERRED EMBODIMENTS

The information processing apparatus relating to the present invention is able to discriminably represent a plurality of components that configure or comprise a product and that assists in product design. The information processing apparatus has an attribute information selection portion that selects the desired two or more pieces of attribute information from the plurality of attribute information of a component. The information processing apparatus further includes a representation selection portion that selects the representations that represent the two or more pieces of attribute information selected in the attribute information selection portion with respect to the respective attribute information. The selection component allows components to be discriminated. A component representation portion is also included that represents the shape of the component based on the representation for which a component-specific attribute value has been selected, in a plurality of selected attribute information.

In addition, the information processing apparatus relating to the present invention in the representation selection portion, provides a representation based on hue, saturation, or lightness selected as the format representing the attribute information of the component.

In addition, the information processing apparatus relating to the present invention in the representation selection portion, provides a representation based on hue, saturation, or transparency selected as the format representing the attribute information of the component.

In addition, the product design assistance program relating to the present invention is is able to discriminably represent a plurality of components that configure a product and that assists in product design. The product design program also causes a computer to execute an attribute information selection that selects the desired two or more pieces of attribute information from the plurality of attribute information of the component. In addition, the product design assistance program includes a representation selection that selects the representations of the two or more pieces of attribute information selected in the attribute information selection. The selection is performed with respect to the respective attribute information in order to discriminate the component.

A component representation that represents the shape of the component based on the representation for which a component-specific attribute value has been selected in the plurality of selected attribute information is also performed.

In addition, the product design assistance method is included within a program that dis represents a plurality of components that configure a product and assist in product design. The method includes an attribute information selection that selects the desired two or more pieces of attribute information from the plurality of attribute information of the component. The method also includes a representation selection that selects the representations of the two or more pieces of attribute information selected in the attribute information selection with respect to the respective attribute information in order to discriminate the component. A component representation is also included in the method. The component representation represents the shape of the component based on the representation for which a component-specific attribute value has been selected in the plurality of selected attribute information.

In addition, the information processing apparatus relating to the present invention comprises an attribute information selection portion that selects the desired two or more pieces of attribute information from a plurality of attribute information of the component. A representation selection portion is provided to select the representations of the two or more pieces of attribute information selected in the attribute information selection portion. The selection is performed with respect to the respective attribute information in order to discriminate the component. A representation synthesis portion is provided to synthesize the two or more representations selected in the representation selection portion. A representation results output portion is also provided to output the representation results synthesized in the representation synthesis portion.

In addition, the information processing apparatus relating to the present invention is able to represent a plurality of items having a plurality of attribute information and that has two or more representations. The apparatus has an attribute information selection portion that selects the desired two or more pieces of attribute information from the plurality of attribute information of the item. The apparatus includes, a representation selection portion that selects the representations of the two or more pieces of attribute information selected in the attribute information selection portion. The selection is performed with respect to the respective attribute information in order to discriminate the item. A component representation portion that represents the shape of the component based on the representation for which a component-specific attribute value has been selected in the plurality of selected attribute information is also provided.

In addition, the information processing apparatus relating to the present invention has an attribute information selection portion that selects the desired two or more pieces of attribute information from a plurality of attribute information of the item. A representation selection portion is also provided that selects the representations of the two or more pieces of attribute information selected in the attribute information selection portion. The selection is performed with respect to the respective attribute information in order to discriminate the item. In addition, a representation synthesis portion that synthesizes the two or more representations selected in the representation selection portion is provided. Finally, a representation results output portion that outputs the representation results synthesized in said representation synthesis portion is provided.

In the present invention, the attribute information is judged by assigning hue, lightness, etc. to the attribute values in the plurality of attribute information and simultaneously displaying a plurality of attribute information. It is therefore possible to eliminate the time and effort of switching the display and to make the work of product design more efficient. In addition, since it is possible to simultaneously evaluate a plurality of attribute information, it is possible to make product design easier even in cases in which decisions relating to product design are difficult based on single pieces of attribute information.

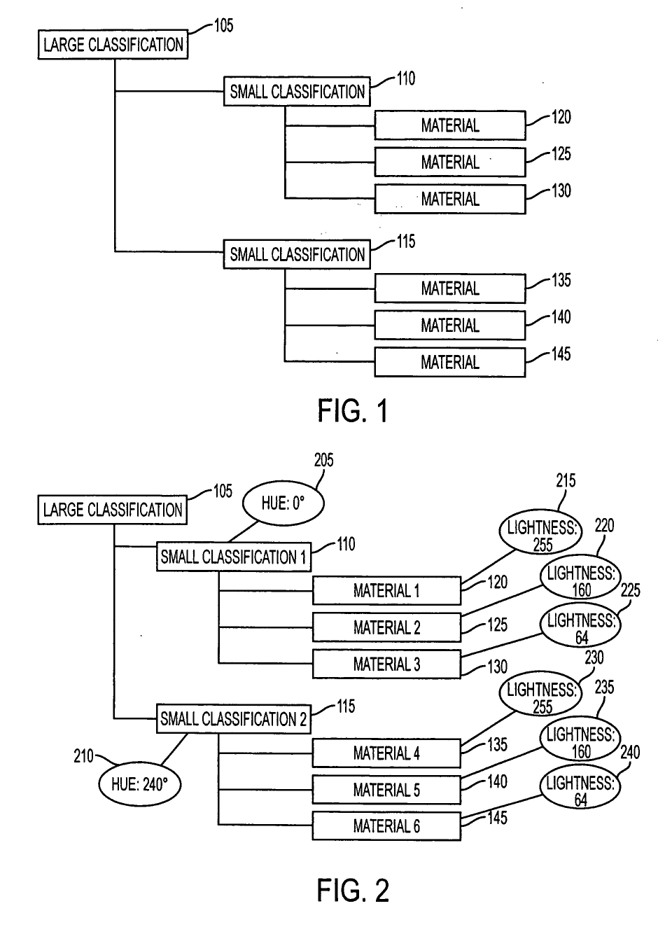

FIG. 1 illustrates materials assigned to a component and an example of classifications for managing the materials. For example, the large or group classification 105 is metal, small or subgroup classification 110 is the iron group, small classification 115 is the non-iron group, material 120 is iron, material 125 is steel, material 130 is cast iron, material 135 is copper, material 140 is aluminum, and material 145 is lead. In order to make the small classifications and the material attributes simultaneously correspond to the display statuses, hue, and lightness, the three color attributes of hue, saturation, and lightness are made to correspond to the respective attributes.

At this time, saturation is considered to be the maximum values of the respective hues. Hue is assigned to the small classification 110 in the classification table, and lightness is assigned to the material. Here, in this embodiment, it is made possible to simultaneously discriminate two types of attributes. In addition, in the case in which one of the attributes of the two types of attributes expresses a classification, hue is assigned to the attribute that is the classification, and lightness is assigned to the other attribute.

FIG. 2 is a drawing in which hue and lightness have been assigned to the classification table. A hue 205 of 0 degrees is assigned to iron group metal that is, small classification 110. A hue 210 of 240 degrees is assigned to non-iron group metal. A lightness 215 of 255 is assigned to the material 120 iron. A lightness 220 of 160 is assigned to material 125 steel. A lightness 225 of 64 is assigned to material 130 cast iron. A lightness 230 of 255 is assigned to material 135 copper. A lightness 140 of 160 is assigned to material 140 aluminum, and a lightness 240 of 64 is assigned to material 145 lead.

In this way, attributes that belong to the same classification are expressed by the same hue, and the individual differences within them can be discriminated by the lightness of the color. And by using hue and lightness, it is possible to simultaneously evaluate the classification and the material of the component.

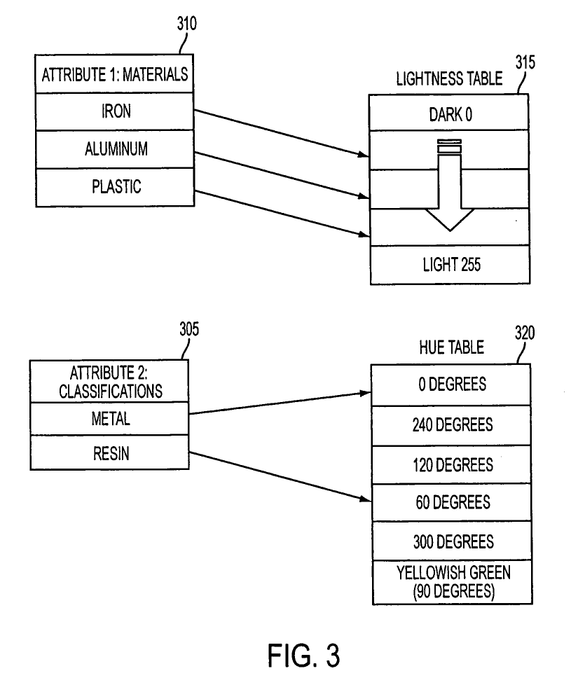

FIG. 3 is a hue and lightness correspondence drawing in the case in which the classifications 305 are metal and resin, and the materials 310 are iron, aluminum, and plastic. The materials 310 are made to correspond to a lightness table 315, and the classifications 305 are made to correspond to the hue table 320.

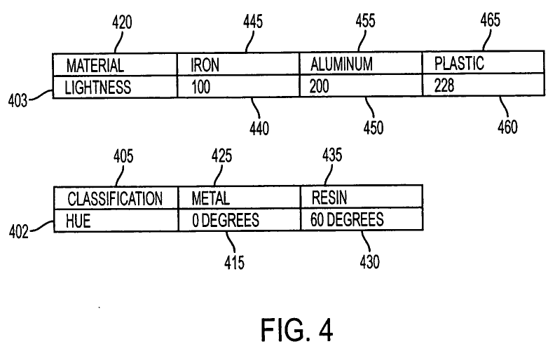

FIG. 4 is a table in which the hue 402 and lightness 403 have respectively been made to correspond to the classification 405 and the material 420. A hue of 0 degrees 415 is assigned to the classification metal 425. A hue of 60 degrees 430 to resin 435; a lightness of 100 440 is assigned to the material iron 445; a lightness of 200 450 to material aluminum 455, and a lightness of 228 460 to plastic 465.

Because human vision is sensitive to changes in lightness more than changes in color, in this exemplary embodiment those in which the respective attributes have a high number of attribute values or range are made to correspond to the lightness, and those which have few are made to correspond to the hue. In addition, the attribute values refer to the properties, etc. of the attribute included in the component. For example, if it is the classification, the attributes values are metal and resin. If it is the material, the attribute values are aluminum and plastic. Also, a hue of 0 degrees is red. A hue of 240 degrees is blue A hue of 120 degrees is green. A hue of 60 degrees is yellow. A hue of 300 degrees is green, and a hue of 90 degrees is yellowish green.

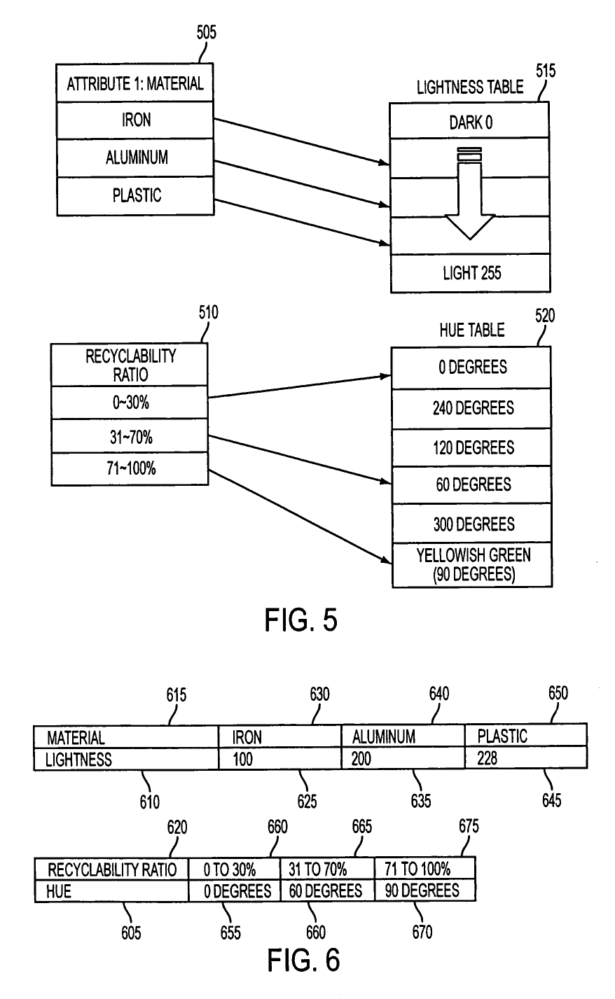

FIG. 5 shows hue and lightness correspondences in the case in which the attributes are the material 505 and recyclability ratio 510, the materials are iron, aluminum, and plastic, and the recyclability ratios are divided into the three levels of 0 to 30%, 31 to 70%, and 71 to 100%.

A lightness table 515 is assigned to the materials, and a hue table 520 is assigned to the recyclability ratios. This may also be the opposite case, and the hue table 520 may be assigned to the materials, and the lightness table 515 may be assigned to the recyclability ratios.

FIG. 6 is a table that corresponds hue 605 and lightness 610 to the material 615 and recyclability ratio 620, in which a lightness of 100 625 is made to correspond to the material iron, a lightness of 200 635 to aluminum 640, and a lightness of 228 645 to plastic 650, and a hue of 0 degrees 655 is made to correspond to a recyclability ratio of 0 to 30% 660, 60 degrees 660 to a recyclability ratio of 31 to 70% 665, and 90 degrees 670 to a recyclability ratio of 71 to 100% 675.

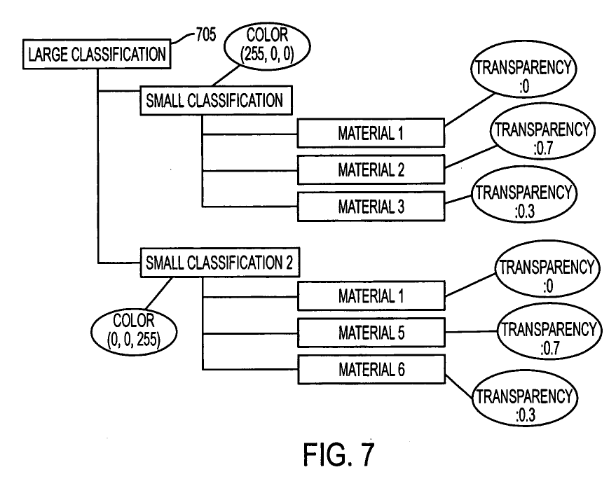

FIG. 7 is a drawing that assigns hue and transparency to the classification table. For example, large classification 705 is metal, small classification 1 is the iron group, small classification 2 is the non-iron group, material 1 is iron, material 2 is steel material, material 3 is cast iron, material 4 is copper, material 5 is aluminum, and material 6 is lead. In the classification table, hue is assigned to the small classification, and transparency is assigned to the material. Here, in this example embodiment, it is possible to simultaneously discriminate two types of attributes.

In addition, in the case in which one attribute of the two types of attributes represents the classification, hue is assigned to the attribute that is the classification, and transparency is assigned to the other attribute. A hue of 0 degrees is assigned to iron group metal, and a hue of 240 degrees is assigned to non-iron group metal, a transparency of 0 is assigned to the material iron, a transparency of 0.7 to steel, a transparency of 0.3 to cast iron, a transparency of 0 to copper, a transparency of 0.7 to aluminum, and a transparency of 0.3 to lead. In this way, it is possible to represent attributes belonging to the same classification using the same hue. It is also, possible to recognize individual differences among these by the transparency of the color, and it is possible to simultaneously evaluate the classification and the material.

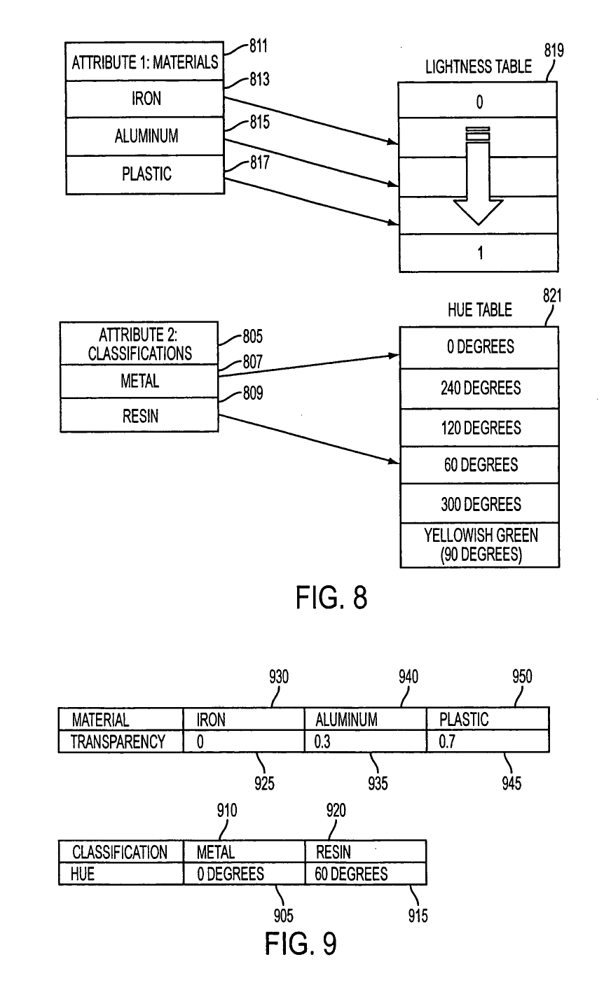

FIG. 8 is a hue and transparency correspondence drawing in a case in which classifications 805 are metal 807 and resin 809. The materials 811 are iron 813, aluminum 815, and plastic 817. The material is made to correspond to the transparency (lightness) table 819, and the classification is made to correspond to the hue table 821.

FIG. 9 is a table which causes a correspondence between the hue and brightness and the classification and material respectively, where a hue of 0 degrees 905 is made to correspond to metal 910, a hue of 60 degrees 915 to resin 920, a transparency of 0 925 to iron 930, a transparency of 0.3 to aluminum 940 and a transparency of 0.7 945 to plastic 950.

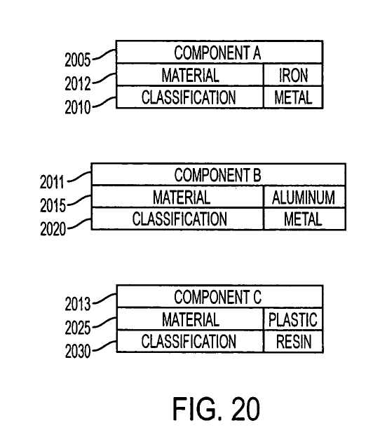

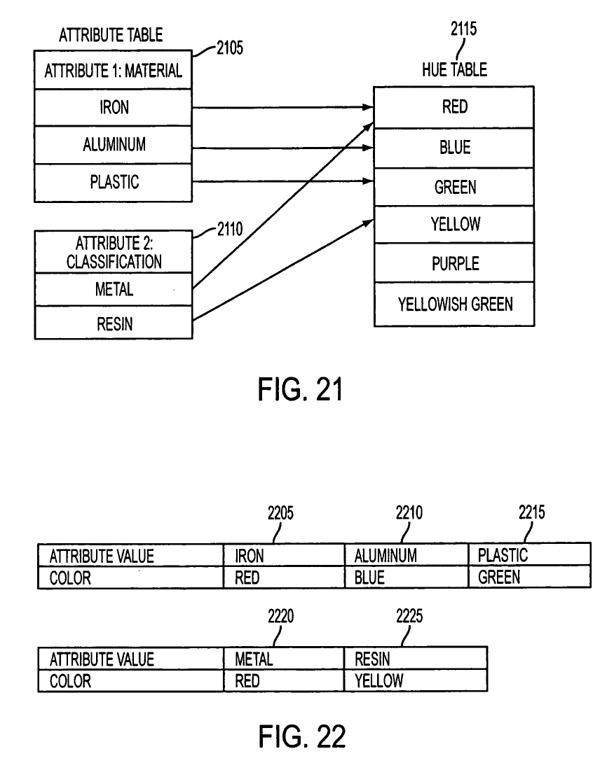

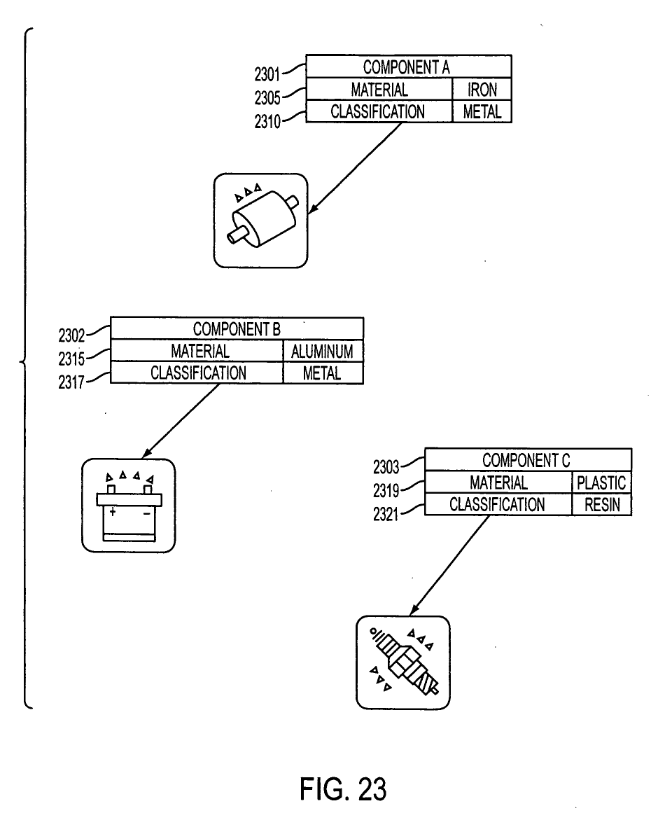

FIG. 20 is a table that shows the attributes of components A 2005, B 2011, and C 2013. For Component 2005 A, the material 2012 is iron, and the classification 2010 is metal, for component B 2011, the material 2015 is aluminum and the classification 2020 is metal, and for component C 2013, the material 2025 is plastic and the classification 2030 is resin. Based on FIGS. 8 and 9, component A 2005 (in FIG. 20) has a transparency of 0 925 and a hue of 0 degrees 905, component B 2011 has a transparency of 0.3 935 and a hue of 0 degrees 905, and component C 2013 has a transparency of 0.7 945 and a hue of 60 degrees 915. Thus, it is possible to generate the component display color based on the correspondence table of these transparencies and hues, and it is possible to display components A, B, and C, which configure the product, by means of colors that take into account two types of attributes.

Through this, it is possible to represent attributes belonging to the same classification using the same hue. It is also possible to recognize individual differences among these by the transparency of the color, and it is possible to simultaneously evaluate the classification and the material.

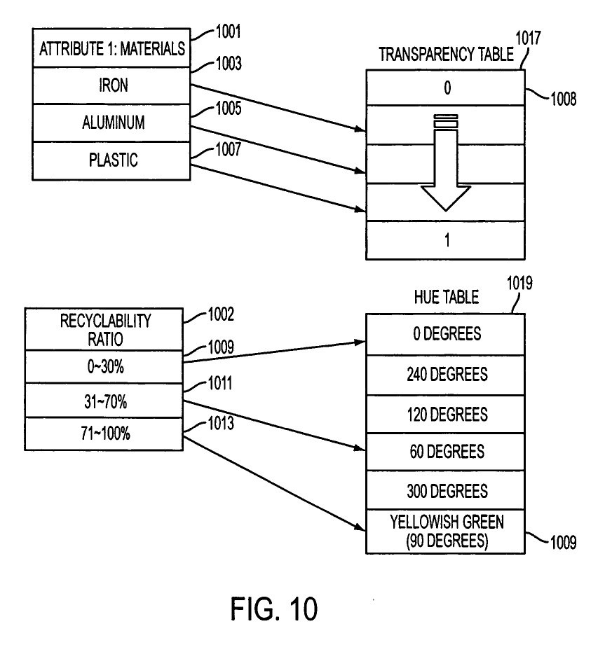

FIG. 10 shows hue and transparency correspondences in a case in which classifications are material 1001 and recyclability ratio 1002. The materials are iron 1003, aluminum 1005, and plastic 1007. The recyclability ratios are divided into the three levels of 0 to 30% 1009, 31 to 70% 1011, and 71 to 100% 1013. A transparency table is assigned to the materials, and a hue table 1019 is assigned to the recyclability ratios. This may also be the opposite case, and the hue table 1019 may be assigned to the materials, and the transparency table 1017 may be assigned to the recyclability ratio 1002.

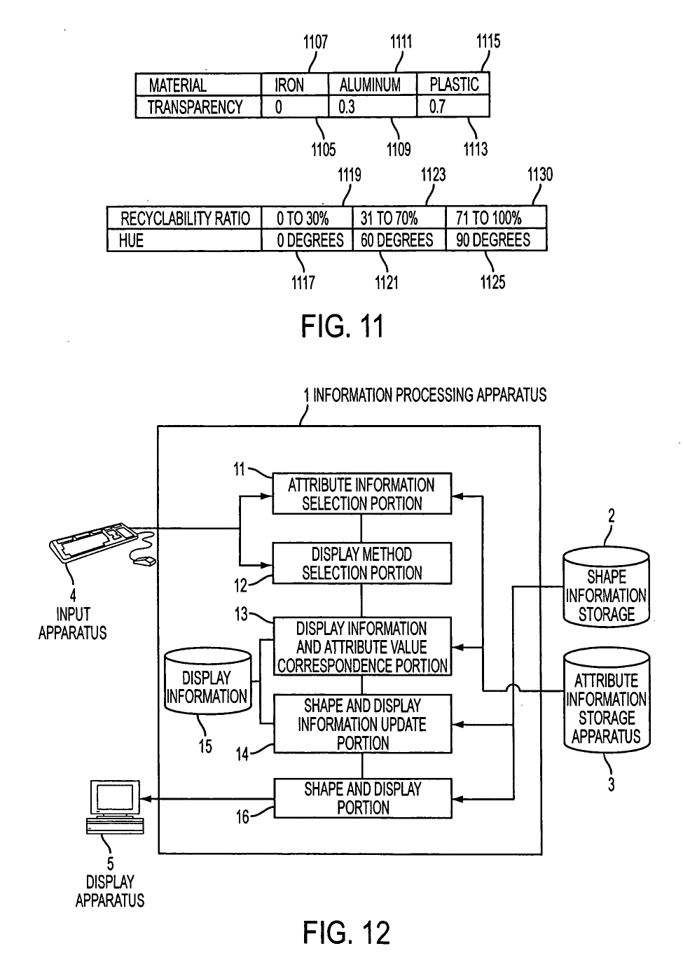

FIG. 11 is a table that corresponds hue and transparency to the material and recyclability ratio, in which a transparency of 0 1105 is made to correspond to iron 1107, a transparency of 0.3 1109 to aluminum 1111, a transparency of 0.7 1113 to plastic 1115, a hue of 0 degrees 1117 is made to correspond to a recyclability ratio of 0 to 30% 1119, 60 degrees 1121 to a recyclability ratio of 31 to 70% 1123, and 90 degrees 1125 to a recyclability ratio of 71 to 100% 1130.

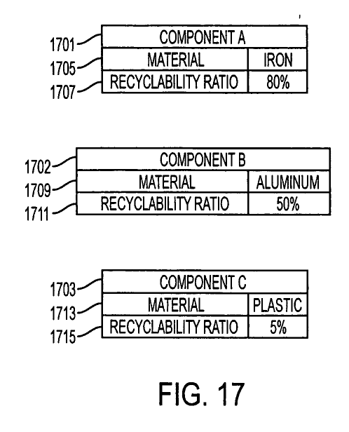

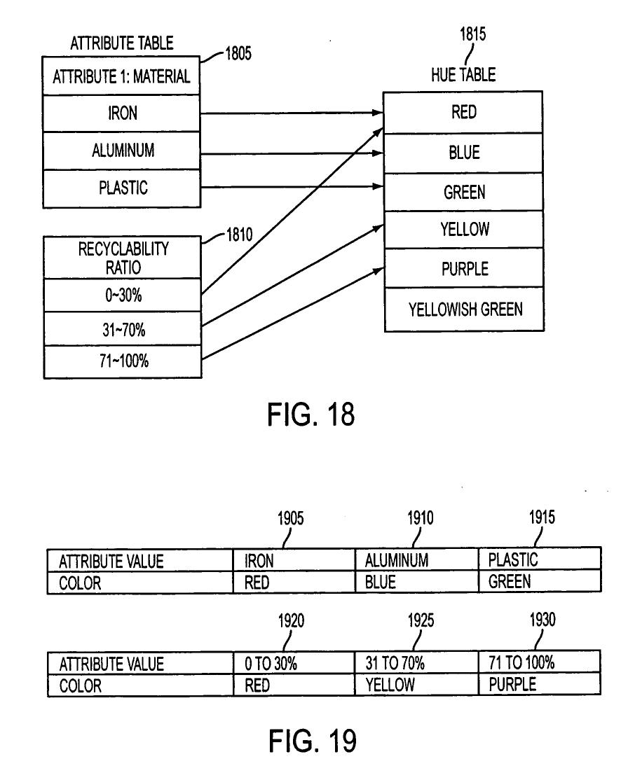

FIG. 17 is a table that shows the attributes of components A 1701, B 1702, and C 1703. For component A 1701, the material 1705 is iron, and the recyclability ratio 1707 is 80 percent. For component B 1702, the material 1709 is aluminum and the recyclability ratio 1711 is 50 percent. For component C 1703, the material 1713 is plastic and the recyclability ratio 1715 is 5 percent. Based on FIGS. 10 and 11, component A 1701 (FIG. 17) has a transparency of 0 1008 and a hue of 90 degrees 1009, component B 1702 has a transparency of 0.3 1108 and hue of 60 degrees 1121, and component C has a transparency of 0.7 1113 and a hue of 0 degrees 1117. Thus, it is possible to generate component display colors from the transparency and hue correspondence tables 1017 and 1014, respectively, and to display components A, B, and C, which configure the product, using colors that take into account two types of attributes.

Through this, it is possible to represent attributes belonging to the same classification using the same hue, and it is possible to recognize individual differences among these by the transparency of the color. It is also possible to simultaneously evaluate the material and the recyclability ratio.

FIG. 12 is a block diagram of an information processing apparatus relating to the present invention. 1 is an information processing apparatus, 2 is a shape information storage apparatus, 3 is an attribute information storage apparatus, 4 is an input apparatus, and 5 is a display apparatus. Information processing apparatus 1 consists of an attribute information selection portion 11, a display method selection portion 12, a display information and attribute value correspondence portion 13, a shape and display information update portion 14, a display information storage portion 15 and a shape display portion 16.

Shape information is stored in the shape information storage apparatus 2, and attribute information is stored in the attribute information storage apparatus 3. Shape information refers to information for discriminating the external appearance of a component, and attribute information refers to the material information used in the component or to the creator, creation date, and the recyclability ratio, reusability ratio, etc. of the component. Here, the recyclability ratio shows the efficiency that can be used in new product manufacturing without processing that component.

The reusability ratio shows the efficiency that can be used in new product manufacture by reprocessing the component such as by heat treatment. In addition, in this exemplary embodiment, a shape information storage apparatus 2 and an attribute information storage apparatus 3 are provided outside the information processing apparatus 1, but it is not limited to this, and shape information storage apparatus 2 and attribute information storage apparatus 3 may also be provided inside the information processing apparatus 1.

In the attribute information selection portion 11, attribute information that assigns lightness, etc. is selected from the attribute information storage apparatus 3. In the display method selection portion 12, a selection is made as to whether to use and display any of the lightness, hue, or saturation with respect to the attribute information selected in the attribute information selection portion 11. In the display information and attribute value correspondence portion 13, a correspondence is made between the selected product attribute information and the selected lightness, etc., and assignment is performed. In the shape and display information update portion 14, the attribute information display format is updated along with the output format of the display apparatus 5. Display information such as the format that displays the attribute information for displaying the component is appropriately stored in the display information storage portion 15. The shape display portion 16 displays the component shape by means of the display format updated in the shape and display information update portion 14, sends it to the display apparatus 5, and performs display output of the shape of the component by means of the display apparatus 5. Here, the representation selection portion corresponds to the display method selection portion 12 in the example of the embodiment, and the component representation portion corresponds to the shape display portion 16.

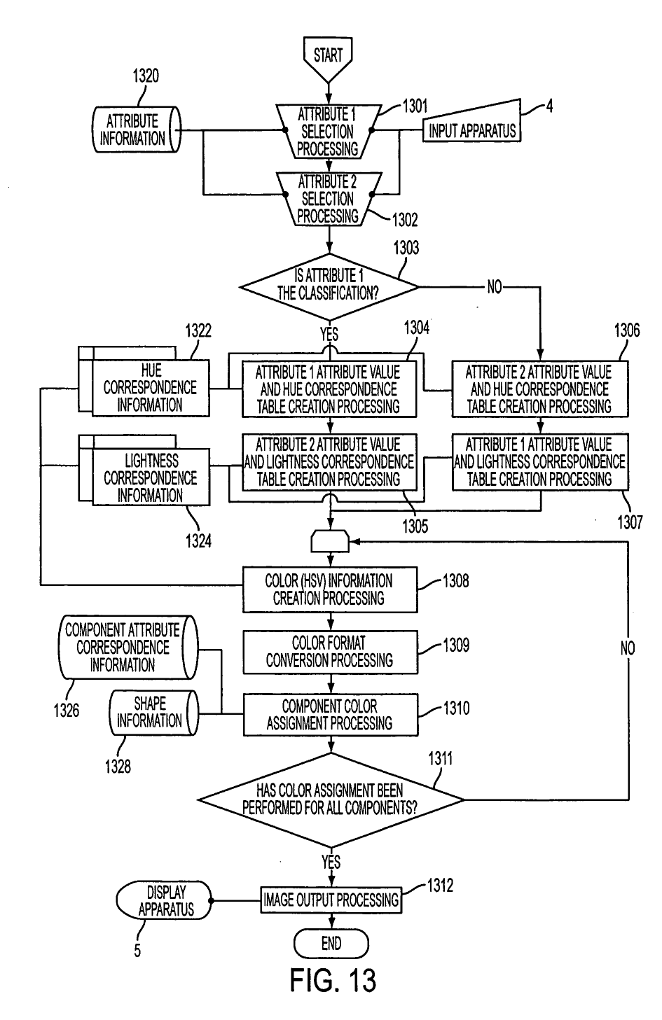

FIG. 13 is a flowchart relating to the present invention. In order to display the components that configure the product, any two types from among the hue, saturation, lightness, and transparency are used. In this example of embodiment, two types of attributes of the component are displayed, and the hue is assigned to one attribute of the component. Lightness or transparency is assigned to the remaining attribute.

First, attribute 1 and attribute 2 are selection processed from the attribute information 1320 stored in the attribute information storage apparatus 3 of FIG. 12 using the input apparatus 4 (steps 1301 and 1302). Here, attributes 1 and 2 are the two attributes selected from the attributes of the components of the product, and they have had numbers added in terms of format.

In step 1303, a determination is made as to whether the selected attribute 1 is the classification. In the case in which attribute 1 is the classification, hue correspondence information 1322 is accessed, and a correspondence table with the hue and the attribute value included in the component classification is creation processed in step 1304. Then, with respect to attribute 2 that shows an attribute other than the classification, lightness correspondence information 1324 is accessed, and a correspondence table with the lightness and the attribute value of attribute 2 is creation processed in step 1305.

In the case in which attribute 1 is not the classification, hue correspondence information is accessed, a correspondence table with the hue and the attribute value of attribute 2 is creation processed, lightness correspondence information is accessed, and a correspondence table with the lightness and the attribute value of attribute 1 is creation processed in steps 1306 and 1307. Based on the hue correspondence table and lightness correspondence table created with respect to attribute 1 and attribute 2 respectively, color information creation processing is performed according to the HSV format in step 1308.

Then, a format that displays the component is conversion processed to RGB format from HSV format in step 1309. Component attribute correspondence information 1326 and shape information 1328 are accessed, and processing that assigns colors to the components that configure the product is performed in step 1310. Then, a determination is made as to whether color assignments have been made for all components in step 1311.

Here, it is not necessary for the components to which colors are to be assigned to be all of those displayed on the display apparatus 5. One may assign colors in advance and select the components that one would like to display, and determine whether color assignment has been performed with respect to these. In the case in which color assignment has been performed for all components, the display apparatus 5 is used to perform product image output in step 1312. In the case in which color assignment has not been performed for all of the components, color (HSV) information creation processing is again performed in step 1308.

Here, in the case color assignment has not been completely performed for all of the components, one may again carry this out from color assignment processing to the components in step 1310.

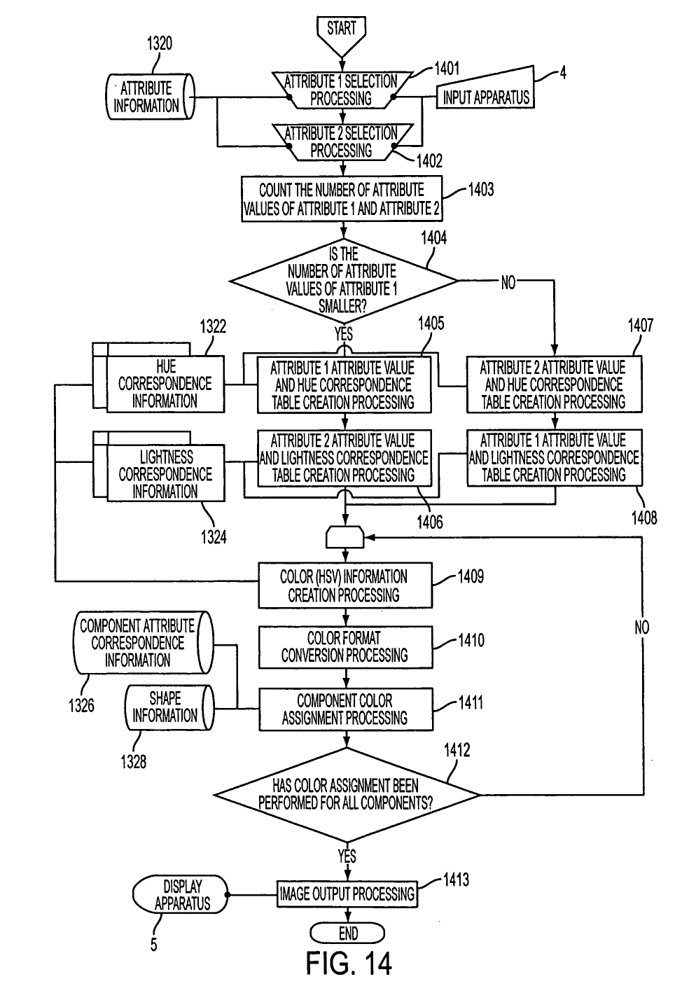

FIG. 14 is a flowchart relating to the present invention.

First, attribute 1 and attribute 2 are selection processed from the attribute information 1320 stored in the attribute information storage apparatus 3 using an input apparatus 4 in steps 1401 and 1402. Here, attributes 1 and 2 are the two attributes selected from the attributes of the components of the product, and they have had numbers added in terms of format. Then, the number of attribute values of attribute 1 and attribute 2 are counted in step 1403.

A determination is made as to whether the attribute value of attribute 1 is less than the number of attribute values of attribute 2 in step 1404. In the case in which the attribute value of attribute 1 is less than the number of the attribute values of attribute 2, hue correspondence information 1322 is accessed, and a correspondence table with the hue and the attribute value of attribute 1 is creation processed, lightness correspondence information is accessed, and a correspondence table with the lightness and the attribute value of attribute 2 is creation processed in steps 1405 and 1406.

In a case in which the attribute value of attribute 1 is more than the number of the attribute values of attribute 2, hue correspondence information 1322 is accessed, and a correspondence table with the hue and the attribute value of attribute 2 is creation processed, lightness correspondence information 1324 is accessed, and a correspondence table with the lightness and the attribute value of attribute 1 is creation processed in steps 1407 and 1408.

Based on the hue correspondence table and lightness correspondence table created with respect to attribute 1 and attribute 2 respectively, color information creation processing is performed according to the HSV format in step 1409. Then, a color format that displays the component is conversion processed to RGB format from HSV format in step 1410. Component attribute correspondence information 1326 and shape information 1328 are accessed, and processing that assigns colors to the components that configure the product is performed in step 1411. Then, a determination is made as to whether color assignments have been made for all components in step 1412.

Here, it is not necessary for the components to which colors are to be assigned to be all of those displayed on the display apparatus 5, and one may assign colors in advance and select the components that one would like to display and determine whether color assignment has been performed with respect to these. In the case in which color assignment has been performed for all components, the display apparatus 5 is used to perform product image output in step 1413.

In the case in which color assignment has not been performed for all of the components, color (HSV) information creation processing is again performed in step 1409. Here, in the case color assignment has not been completely performed for all of the components, one may again carry this out from color assignment processing to the components in step 1411.

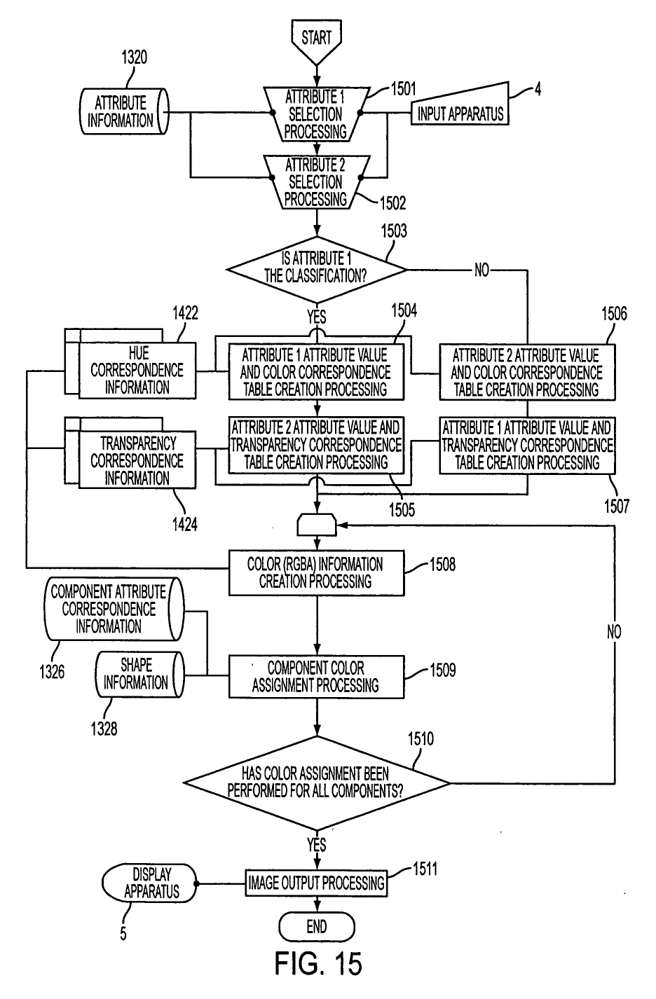

FIG. 15 is a flowchart relating to the present invention.

First, attribute 1 and attribute 2 are selection processed from the attribute information 1320 stored in the attribute information storage apparatus 3 using an input apparatus 4 in steps 1501 and 1502. Here, attributes 1 and 2 are two attributes selected from the attributes of the components of the product, and they have had numbers added in terms of format. Then, a determination is made as to whether the selected attribute 1 is the classification in step 1503.

In the case in which attribute 1 is the classification, hue (color) correspondence information is accessed, and a correspondence table with the hue and the attribute value included in the component classification is creation processed in step 1504. Then, with respect to attribute 2 that shows an attribute other than the classification, lightness (transparency) correspondence information 1424 is accessed, and a correspondence table with the lightness and the attribute value of attribute 2 is creation processed in step 1505.

In a case in which attribute 1 is not the classification, the hue correspondence information is accessed; a correspondence table with the hue and the attribute value of attribute 2 is creation processed; lightness correspondence information is accessed; and a correspondence table with the lightness and the attribute value of attribute 1 is creation processed in steps 1506 and 1507. Based on the hue correspondence table and lightness correspondence table created with respect to attribute 1 and attribute 2 respectively, color information creation processing is performed according to the RGB format in step 1508.

Component attribute correspondence information and shape information are accessed, and processing that assigns colors to the components that make up the product is performed in step 1509. Then, a determination is made as to whether color assignments have been made for all components in step 1510. In the case in which color assignment has been performed for all components, the display apparatus is used to perform product image output in step 1511. In the case in which color assignment has not been performed for all of the components, color (HSV) information creation processing is again performed in step 1508.

Here, in the case color assignment has not been completely performed for all of the components, one may again carry this out from color assignment processing to the components in step 1509.

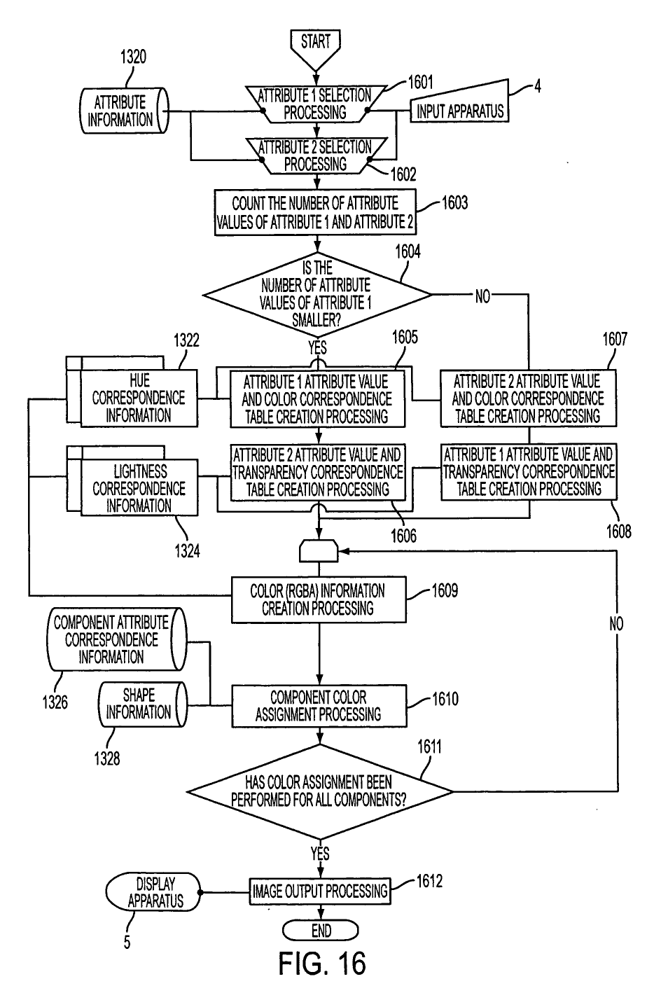

FIG. 16 is a flowchart relating to the present invention.

First, attribute 1 and attribute 2 are selection processed from the attribute information 1320 stored in the attribute information storage apparatus 3 using an input apparatus 4 in steps 1601 and 1602. Here, attributes 1 and 2 are the two attributes selected from the attributes of the components of the product, and they have had numbers added in terms of format. Then, the number of attribute values of attribute 1 and attribute 2 are counted in step 1603. A determination is made as to whether the attribute value of attribute 1 is less than the number of attribute values of attribute 2 in step 1604.

In the case in which the attribute value of attribute 1 is less than the number of the attribute values of attribute 2, hue correspondence information 1322 is accessed, and a correspondence table with the hue attribute value of attribute 1 is creation processed; lightness correspondence information 1324 is accessed, and a correspondence table with the lightness and the attribute value of attribute 2 is creation processed in steps 1605 and 1606.

In the case in which the attribute value of attribute 1 is more than the number of the attribute values of attribute 2, hue correspondence information 1322 is accessed, and a correspondence table with the hue and the attribute value of attribute 2 is creation processed, lightness correspondence information 1324 is accessed, and a correspondence table with the lightness and the attribute value of attribute 1 is creation processed in steps 1607 and 1608.

Based on the hue correspondence table and lightness correspondence table created with respect to attribute 1 and attribute 2 respectively, color information creation processing is performed according to the RGB format in step 1609. Component attribute correspondence information 1326 and shape information 1328 are accessed, and processing that assigns colors to the components that configure the product is performed in step 1610. Then, a determination is made as to whether color assignments have been made for all components in step 1611.

In the case in which color assignment has been performed for all components, the display apparatus 5 is used to perform product image output in step 1612. In the case in which color assignment has not been performed for all of the components, color information creation processing is again performed according to RGB format in step 1609.

Here, in the case where color assignment has not been completely performed for all of the components, one may again carry this out from assignment processing that assigns color to the components in step 1610. Next, presented below is an addendum of modifications of the example of embodiment of the information processing apparatus relating to the present invention discussed above and other technical expansion items, etc.

(1) In the above examples of embodiments of the invention, it is possible to simultaneously discriminate two types of attributes from among the attributes that the component has, but it is not limited to this. It may also be possible to simultaneously discriminate two or more attributes.

(2) In the above examples of embodiments of the invention, the shape of the component is visually represented based on color. Design assistance is performed, but it is not limited to this, and other representations may be used, such as using audio to represent the shape of the component, for example.

(3) In the above examples of embodiment of the invention, in common computers, colors are represented as RGB (red, green, blue). Thus, in the case of output to the display apparatus 5, display is performed using RGB format, but it is not limited to this, and HSV format (hue, saturation, lightness), CMY (cyan (C), magenta (M), yellow (Y)) format, etc. may be used.

(4) In the above examples of embodiments of the invention, an input apparatus and display apparatus, etc. are arranged outside the information processing apparatus, but it is not limited to this. For example, they may be provided inside the information processing apparatus.

(5) In the above examples of embodiment of the invention, component shape information and attribute information are stored within separate storage apparatus, but it is not limited to this. For example, they may be stored within one storage apparatus.

(6) In the above examples of embodiments of the invention, classification, material, and recyclability ratio were explained as examples of component attributes, but it is not limited to this. For example, it is possible to assign colors to attributes such as the reusability ratio and then discriminate the components.

The present invention is not limited to the examples disclosed herein.

What is claimed is:

1. An information processing apparatus capable of discriminably representing a plurality of components that configure a product and that assists in product design, said information processing apparatus comprising:
an attribute information selection portion that selects two or more pieces of attribute information from attribute information of the component;
a representation selection portion that selects representations of the two or more pieces of attribute information with respect to respective attribute information to discriminate the component; and
a component representation portion that represents shape of the component based on the representation for which a component-specific attribute value has been selected in the selected attribute information.

2. The information processing apparatus of claim 1, in which said representation selection portion and at least one representation based on hue, saturation, or lightness are selected as a format that represents the attribute information of the component.

3. The information processing apparatus described in claim 1 in which said representation selection portion selects at least one representation based on hue, saturation, or transparency as the format that represents the attribute information of the component.

4. The information processing apparatus of claim 1, wherein component classification and component material attribute information are selected from the attribute information of the component.

5. The information processing apparatus of claim 1, wherein component classification and component recyclability ratio attribute information are selected from the attribute information of the component.

6. An information processing apparatus capable of discriminably representing a plurality of components that configure a product and that assists in product design, comprising:
an attribute information selection portion that selects two or more pieces of attribute information from attribute information of the component;
an attribute value count portion that counts component attribute values that show the selected attribute information;
a representation assignment portion that assigns a representation based on hue to attribute information whose attribute value is high and assigns a representation based on lightness to attribute information whose attribute value is low; and
a component representation portion that represents shape of the component based on a representation assigned in said representation assignment portion in the two or more pieces of attribute information.

7. The information processing apparatus of claim 6, wherein a representation based on hue for attribute information whose attribute value is high and a representation based on transparency are assigned to attribute information whose attribute value is low in said attribute value count portion.

8. A computer readable storage for controlling a computer and comprising a product design assistance program that is able to discriminably represent a plurality of components that configure a product and that assists in product design, said product design assistance program causing a computer to execute:
attribute information selection that selects desired two or more pieces of attribute information from attribute information of a component,
representation selection that selects representations that represent two or more pieces of attribute information selected in said attribute information selection with respect to respective attribute information in order to discriminate the component, and
component representation that represents shape of the component based on representation for which a component-specific attribute value has been selected in the selected attribute information.

9. A product design assistance method that is able to discriminably represent a plurality of components that configure a product and that assists in product design, said product design assistance method comprising:
attribute information selection that selects two or more desired pieces of attribute information from attribute information of the component;
representation selection that selects the representations that represent the two or more pieces of attribute information selected in said attribute information selection with respect to respective attribute information in order to discriminate a component;
and component representation that represents shape of the component based on representation for which a component-specific attribute value has been selected in the selected attribute information.

10. An information processing apparatus that is able to discriminably represent a plurality of components that configure a product and that assists in product design, said information processing apparatus comprising:
an attribute information selection portion that selects two or more desired pieces of attribute information from attribute information of the component;
a representation selection portion that selects representations that represent two or more pieces of attribute information selected in said attribute information selection portion with respect to respective attribute information in order to discriminate a component,
a representation synthesis portion that synthesizes two or more representations selected in said representation selection portion,
and a representation results output portion that outputs representation results synthesized in said representation synthesis portion.

11. An information processing apparatus that is able to represent a plurality of items having a plurality of attribute information and that has two or more representations, said information processing apparatus comprising:
an attribute information selection portion that selects two or more desired pieces of attribute information from attribute information of the item;
a representation selection portion that selects the representations that represent the two or more desired pieces of attribute information selected in said attribute information selection portion with respect to respective attribute information in order to discriminate the item; and
a component representation portion that represents shape of the component based on the representation for which a component-specific attribute value has been selected in the selected attribute information.

12. An information processing apparatus that is able to represent a plurality of items having a plurality of attribute information and that has two or more representations, said information processing apparatus comprising:
an attribute information selection portion that selects two or more desired pieces of attribute information from the attribute information of the item;
a representation selection portion that selects the representations that represent the two or more desired pieces of attribute information selected in said attribute information selection portion with respect to respective attribute information in order to discriminate the item,
a representation synthesis portion that synthesizes the two or more representations selected in said representation selection portion; and
a representation results output portion that outputs representation results synthesized in said representation synthesis portion.

13. An method for aiding design of an item, comprising:
selecting attribute information from the item;
selecting representations of the attribute information; and
representing shape of the item based on the representation.

14. The method of claim 13, wherein the attribute information includes information pertaining to recyclability ratio.

15. The method of claim 13, wherein the attribute information includes information pertaining to material of the item.

16. The method of claim 13, wherein the representations are based on hue, saturation, or transparency of the item.

17. An information processing method for discriminably representing a plurality of components that configure a product, comprising:
selecting attribute information from attribute information of the component;
counting component attribute values that show the selected attribute information;
assigning a hue representation to attribute information including a high value;
assigning a lightness representation to attribute information including a low value.

18. The information processing method of claim 17, further comprising synthesizing the representations.

19. The information processing method of claim 18, further comprising outputting said synthesized representations.
